(19) United States
(12) Patent Application Publication
(10) Pub. No.: US 2006/0203883 A1
(43) Pub. Date: Sep. 14, 2006

(54) Temperature sensing

(75) Inventor: Jed Griffin, Forest Grove, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Intel Corporation

(21) Appl. No.: 11/075,491

(22) Filed: Mar. 8, 2005

(51) Int. Cl. G01K 7/00; G01K 1/00

(52) U.S. Cl. 374/178; 374/170

(57) ABSTRACT

Temperature sensing circuits are provided herein. In some embodiments, they comprise first and second transistors coupled together in a current mirror configuration and first and second diodes. The first diode is coupled to the first transistor, and the second diode is coupled to the second transistor. A temperature sensing signal is generated between the first and second diodes when the circuit is being operated. Other embodiments are disclosed and/or claimed herein.

### TECHNICAL FIELD

Embodiments disclosed herein relate generally to temperature sensing circuits.

### BACKGROUND

Temperature sensor circuits are commonly used in a variety of applications including temperature monitoring in a chip. (As used herein, the term “chip” (or die) refers to a piece of a material, such as a semiconductor material, that includes a circuit such as an integrated circuit or a part of an integrated circuit.) A temperature sensing circuit typically generates a signal that is indicative of the circuit's temperature and thus the temperature around the circuit (e.g., in a region of a chip around the circuit). For example, such a circuit may be used to prevent device destruction due to over-heating when the temperature within a device becomes excessive. On the other hand, it might be used to know when it is okay to fully drive a device (e.g., operate a microprocessor at maximum power and/or frequency).

Unfortunately, conventional temperature sensing circuits may be inaccurate or impractical to utilize because they generally do not provide a linear temperature response signal over a reasonable range of temperatures. For example, so called bandgap temperature sensor circuits are commonly used to monitor internal chip temperature, but they generate a non-linear temperature response signal. Thus, their use is normally limited to narrow temperature ranges where the response sufficiently approximates a linear response. Other types of sensor circuits are more linear but can be impractical. For example, sensors using resistors made from different metals with varying resistivities can generate fairly linear temperature response signals but may not be feasible in certain applications.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a schematic diagram of one embodiment of a temperature sensing circuit.

FIG. 2 is a schematic diagram of another embodiment of a temperature sensing circuit with a differential amplifier circuit.

FIG. 3 is a schematic diagram of the temperature sensing circuit of FIG. 1 with an embodiment of a differential amplifier circuit.

FIG. 4 is a block diagram of a system having a processor chip with a temperature sensing circuit in accordance with some embodiments of the present invention.

### DETAILED DESCRIPTION

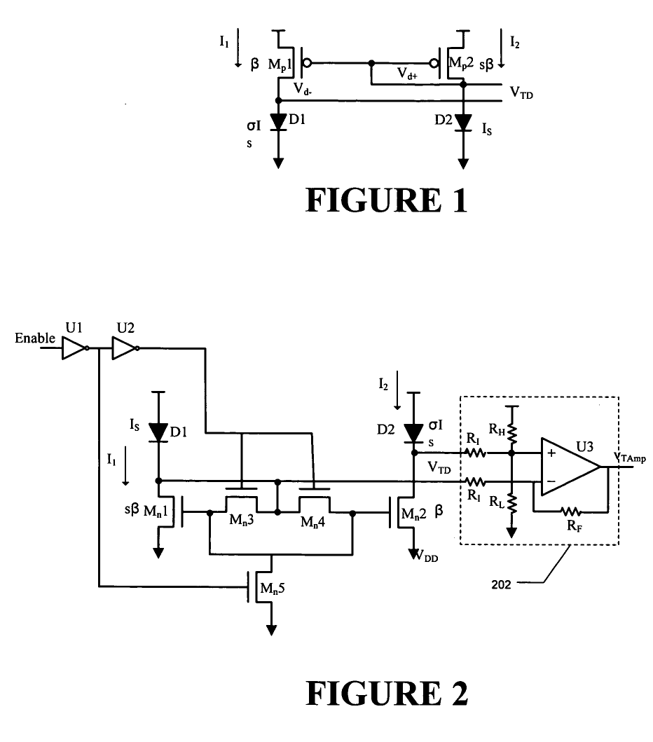

FIG. 1 shows one embodiment of a current mirrored linear (“CML”) temperature sensing circuit. In the depicted embodiment, the circuit comprises first and second PMOS transistors Mₚ1 and Mₚ2 and first and second diodes D1 and D2. (The term “PMOS transistor” refers to a P-type metal oxide semiconductor field effect transistor. Likewise, “NMOS transistor” refers to P-type metal oxide semiconductor field effect transistor. It should be appreciated that whenever the terms: “transistor”, “MOS transistor”, “NMOS transistor”, or “PMOS transistor” are used, unless otherwise expressly indicated or dictated by the nature of their use, they are being used in an exemplary manner. Other suitable transistor types, e.g., junction-field-effect, bipolar-junction-transistor, known today or not yet developed, could be used in their place.)

As indicated, D1 and Mp1 are connected in series between VDD and VSS and have an associated current I1. Likewise, D2 and Mp2 are connected in series between VDD and VSS and have an associated current 12. Transistors Mp1 and Mp2 are connected together in a current mirror configuration with I1 following I2. Transistor Mp1 has a transconductance parameter, β, that is s times greater (s is a scale factor) than that of Mp2. For example, it could have a channel width s times larger than the channel width of Mp2. Accordingly, I₁=sI₂. On the other hand, diode D2 has a saturation current parameter, Iₛ, that is σ times greater than the 1 of D1, e.g., D2 has a PN junction cross-sectional area that is a times larger than that of D1.

This circuit generates a differential voltage, V_{TD}(Vd+−Vd−), that has a linear response with respect to the temperature of the diodes (which are assumed to be substantially at the same temperature). The equation for this temperature signal is given by:

$$I = {I}_{S} ( {ⅇ}^{\frac{V}{{nV}_{T}}} )$$

where Iₛ is the diode's saturation current parameter, V_{T} is its thermal voltage parameter, and n is a physical semiconductor material parameter (generally ranging between 1 and 2). The current in a PMOS transistor when it is operated in the saturation region (as it typically is with a current mirror) is given by:

$$I = \frac{β}{2} {( {V}_{SG} - {V}_{TH} )}^{2}$$

where β is the transistor's transconductance parameter, V_{SG} is the voltage drop between its source and gate, and V_{Th} is its threshold voltage parameter. With the depicted circuit, I₁ is equal to the D1 current, which is equal to the source-to-drain current in M_{P}1. Thus,

$${I}_{1} = σ {I}_{S} ( {ⅇ}^{\frac{{V}_{d -}}{{nV}_{T}}} ) = \frac{β}{2} {( {V}_{DD} - {V}_{d +} - {V}_{Th} )}^{2}$$

Similarly, I₂ is equal to the D2 current, which is equal to the source-to-drain current in M_{P}2. Thus,

$${I}_{2} = {I}_{S} ( {ⅇ}^{\frac{{V}_{d +}}{{nV}_{T}}} ) = \frac{s β}{2} {( {V}_{DD} - {V}_{d +} - {V}_{hT} )}^{2}$$

(Note, it is assumed that V_{Th} is substantially the same for both transistors and V_{T} is substantially the same for both diodes. In different applications, depending on needed accuracy, these assumptions may be achieved to varying degrees.) The equations can be algebraically combine as follows:

$$\frac{σ {I}_{S} ( {ⅇ}^{\frac{{V}_{d -}}{{nV}_{T}}} )}{{I}_{S} ( {ⅇ}^{\frac{{V}_{d +}}{{nV}_{T}}} )} = \frac{\frac{β}{2} {( {V}_{DD} - {V}_{d +} - {V}_{Th} )}^{2}}{\frac{s β}{2} {( {V}_{DD} - {V}_{d +} - {V}_{Th} )}^{2}}$$

$$which reduces to$$

$$σ ( {ⅇ}^{\frac{- {V}_{d -} + {V}_{d +}}{{nV}_{T}}} ) = \frac{1}{s}$$

$$or$$

$${ⅇ}^{\frac{{V}_{TD}}{{nV}_{T}}} = σ s$$

$$or$$

$$\frac{{V}_{TD}}{{nV}_{T}} = ln ( σ s )$$

$$and thus$$

$${V}_{TD} = {nV}_{T} ln ( σ s )$$

Since V_{T} (the thermal voltage parameter for the diodes) is equal to KT/q, where K is the Boltzmann constant, q is the charge of an electron, and T is the temperature (in degrees Kelvin), this equation can be expressed as

$${V}_{TD} = \frac{nk ln ( σ s )}{q} {T}_{K}$$

$$or$$

$${V}_{TD} = ( \frac{n ln ( σ s ) k}{q} ) ( {T}_{c} + 273.15 )$$

where T_{c} is the temperature in degrees Celsius.

As the equation for V_{TD} shows, the output voltage has a very linear relationship to temperature. The nonlinearities of the semiconductor devices are canceled out in the differential voltage (V_{TD}) function. When the scale factors, s and σ, are kept relatively large, a robust, substantially linear voltage to temperature signal can be attained over a relatively wide temperature range. for example, in one embodiment, scale factors of s=20 and σ=35 are used resulting in a temperatures sensing range of −5° C. to 130° C. with the measured temperature being accurate to within 1°. (With this embodiment, a 0.16 μm process is used; PMOS transistors having channel lengths of 0.64 μm and widths of 800 [Mₚ1] and 40 μm [Mₚ2] are used; and the diodes are formed from PN junctions with cross-sectional areas of approximately 267 μm² [D1] and 9356 μm² [D2].)

Another benefit of having a relatively high sa scale product is that a large amount of amplification can occur in the temperature sensing circuit itself thereby reducing the amount of needed downstream amplification, which can be temperature sensitive.

FIG. 2 shows one embodiment of a temperature sensing circuit with a differential amplifier for use in an integrated circuit chip such as a microprocessor. The circuit comprises a temperature sensing circuit (formed from diodes D1 and D2, and NMOS transistors Mₙ1 and Mₙ2) and a differential amplifier 202 for amplifying a temperature-sensing voltage signal V_{TD}. The circuit also includes inverters U1 and U2 and NMOS transistors Mn3 through Mn5 for enabling and disabling the circuit. The temperature sensing circuit is configured akin and operates similarly to the temperature sensing circuit discussed above, except that NMOS transistors (Mₙ1 and Mₙ2) are used instead of PMOS transistors. They are coupled together to form a current mirror with Mₙ1 being scaled larger than Mn2 by a factor s. Accordingly, I₁ equals sI₂. As with the temperature sensing circuit described above, the diode (D2) in the smaller current path (I²) is scaled larger than the other diode (D1) by a scale factor σ. The indicated differential temperature sensing voltage signal (V_{TD}) is characterized by the equation:

$${V}_{TD} = ( \frac{n ln ( σ s ) k}{q} ) ( {T}_{c} + 273.15 )$$

In combination with inverters U1 and U2, transistors Mₙ3, Mₙ4, and Mₙ5 are employed to enable and disable the temperature sensing circuit by way of an “Enable” signal, which is input at U1. When the Enable signal is asserted (High), Mₙ5 turns off (which allows Mₙ1 and Mₙ2 to freely operate) and Mₙ3 and Mₙ4 turn on. This will engage the current mirror between Mₙ1 and Mₙ2 thereby enabling the temperature sensing circuit. Conversely, when the Enable signal is de-asserted (Low), Mₙ3 and Mₙ4 turn off and Mₙ5 turns on thereby disabling it.

The differential amplifier circuit 202 comprises operational amplifier (“op amp”) U3 and resistors R₁, R_{L}, R_{H}, and R_{F}, connected in a conventional differential amplifier configuration including a level shifting function. When R_{F}/R_{I} is equal to R_{H}R_{L}/R_{I}(R_{H}+R_{L}), the amplifier has a gain factor of R_{F}/R_{L} and a level shifting component of

$$\frac{{R}_{L} - {R}_{H}}{{R}_{L} + {R}_{H}} ( \frac{{V}_{DD}}{2} )$$

Thus, the amplified temperature sensing voltage V_{TAmp} is equal to

$${V}_{TAmp} = \frac{{R}_{F}}{{R}_{I}} ( \frac{n ln ( σ s ) k}{q} ) ( {T}_{c} + 273.15 ) + \frac{{R}_{L} - {R}_{H}}{{R}_{L} + {R}_{H}} ( \frac{{V}_{DD}}{2} )$$

In some embodiments, the op amp U3 has a relatively large common mode rejection ratio to reduce error in the amplified temperature signal. Likewise, in some embodiments, one or more noise decoupling capacitors connected across the op amp's power supply rails may be employed to filter out noise, e.g., from a downstream A-to-D converter. (It should be appreciated that while a differential amplifier circuit is shown for amplifying the temperature sensing voltage (V_{TD}), any other suitable amplifier such as a chopper stabilizer circuit could be used.)

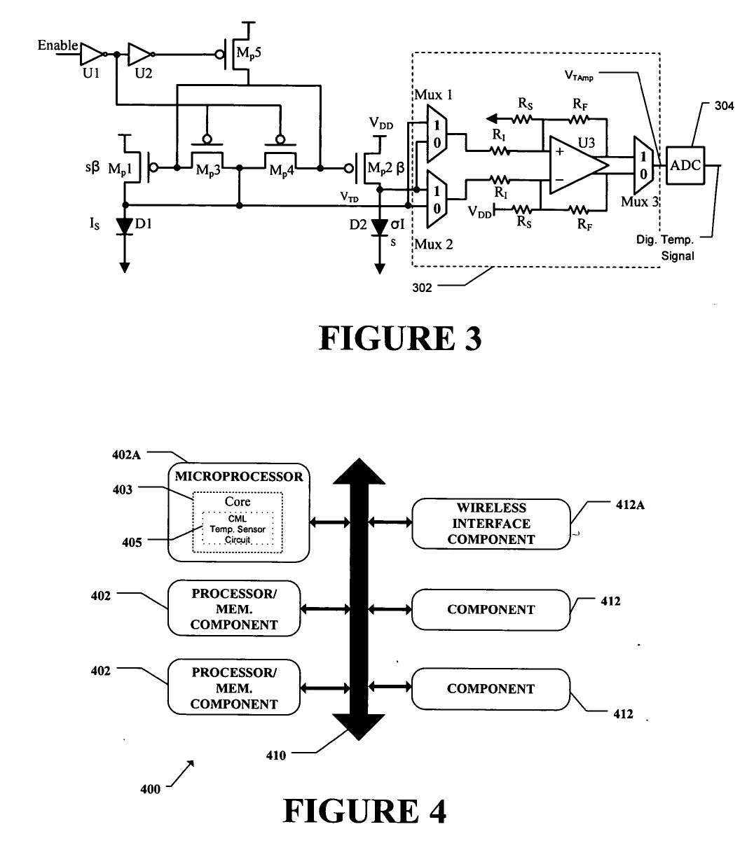

FIG. 3 shows an embodiment of a temperature sensing circuit with an error-reducing amplifier configuration. It generally comprises temperature sensing and enable/disable portions (formed from Mₚ1 to Mₚ5, D1, D2, U1, and U2), a complementary differential amplifier circuit 302, and an A/D converter 304. The temperature sensing and enable/disable circuits operate as discussed above. The temperature sensing circuit generates a differential temperature voltage V_{TD}, which is linearly proportional to the temperature of the diodes. This voltage is amplified by the complementary differential output amplifier 302 thereby producing an amplified temperature signal V_{TAmp}, which is converted to a digital temperature signal at analog to digital converter 304.

The complementary differential amplifier circuit 302 comprises multiplexers Mux 1 to Mux 3, op. amp. U3, and resistors R₁, R_{S}, and R_{F}. With this configuration, complementary outputs of the amplified V_{TD} are provided at the output of the op amp U3. (Negative feedback is provided with respect to each output since the “+” output is fed back to the “−” input, and the “−” output is fed back to the “+” input.) for each output, gain is R_{F}/R_{S}, and is shifted by an offset of −(R_{F}/R_{S})V_{DD}. thus, the output voltage (V_{TAmp}) for each output is given by:

$${V}_{TAmp} = + / - \frac{{R}_{F}}{R} ( \frac{n ln ( σ s ) k}{q} ) ( T + 273.15 ) - \frac{{R}_{F}}{{R}_{S}} ( {V}_{DD} )$$

In operation, the multiplexers may be periodically switched causing the polarity of the input V_{TD} signal to be switched, along with the polarity of the selected output (which normalizes the output signal polarity regardless of the multiplexer states). The dual outputs (within a reasonable amount of time) can then be averaged resulting in noise (e.g., common mode noise) being cancelled out of the output signal. (Such averaging can be performed at any suitable place such as downstream on the digitized temperature signal.)

With reference to FIG. 4, one example of a system (system 400 for a computer) that may be implemented with one or more IC chips or modules (including a microprocessor chip 402A) is shown. System 400 generally comprises one or more processor/memory components 402, an interface system 410, and one or more other components 412. At least one of the one or more processor/memory components 402 is communicatively linked to at least one of the one or more other components 412 through the interface system 410, which comprises one or more interconnects and/or interconnect devices including point-to-point connections, shared bus connections, and/or combinations of the same.

A processor/memory component is a component such as a processor, controller, memory array, or combinations of the same contained in a chip or in several chips mounted to the interface system or in a module or circuit board coupled to the interface system. Included within the depicted processor/memory components is microprocessor chip 402A, which has a core 403 with a current mirrored temperature sensing circuit 405, as disclosed herein. The one or more depicted other components 412 could include any component of use in a computer system such as a sound card, network card, Super I/O chip, or the like. In the depicted embodiment, the other components 412 include a wireless interface component 412A, which serves to establish a wireless link between the microprocessor 402A and another device such as a wireless network interface device or a computer. It should be noted that the system 400 could be implemented in different forms. That is, it could be implemented in a single chip module, a circuit board, or a chassis having multiple circuit boards. Similarly, it could constitute one or more complete computers or alternatively, it could constitute a component useful within a computing system.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chip set components, programmable logic arrays (PLA), memory chips, network chips, and the like. In addition, while in the depicted embodiment, diodes D1 and D2 are formed out of basic PN junctions, it should be appreciated that any suitable semiconductor device such as a transistor or diode-connected transistor could be used.

Moreover, it should be appreciated that example sizes/models/values/ranges may have been given, although the present invention is not limited to the same. As manufacturing techniques (e.g., photolithography) mature over time, it is expected that devices of smaller size could be manufactured. With regard to description of any timing or programming signals, the terms “assertion” and “negation” are used in an intended generic sense. More particularly, such terms are used to avoid confusion when working with a mixture of “active-low” and “active-high” signals, and to represent the fact that the invention is not limited to the illustrated/described signals, but can be implemented with a total/partial reversal of any of the “active-low” and “active-high” signals by a simple change in logic. More specifically, the terms “assert” or “assertion” indicate that a signal is active independent of whether that level is represented by a high or low voltage, while the terms “negate” or “negation” indicate that a signal is inactive. In addition, well known power/ground connections to IC chips and other components may or may not be shown within the FIGS. for simplicity of illustration and discussion, and so as not to obscure the invention. Further, arrangements may be shown in block diagram form in order to avoid obscuring the invention, and also in view of the fact that specifics with respect to implementation of such block diagram arrangements are highly dependent upon the platform within which the present invention is to be implemented, i.e., such specifics should be well within purview of one skilled in the art. Where specific details (e.g., circuits) are set forth in order to describe example embodiments of the invention, it should be apparent to one skilled in the art that the invention can be practiced without, or with variation of, these specific details. The description is thus to be regarded as illustrative instead of limiting.

What is claimed is:

1. A chip, comprising:
a temperature sensing circuit comprising
(i) a current mirror circuit having first and second current mirror paths;
(ii) a first semiconductor device in series with the first current mirror path; and
(iii) a second semiconductor device in series with the second current mirror path, wherein a signal between the first and second semiconductor devices is substantially linearly proportional to the temperature of the circuit.

2. The chip of claim 1, in which the current mirror circuit comprises a first MOS transistor in the first current mirror path and a second MOS transistor in the second current mirror path.

3. The chip of claim 2, in which the first semiconductor device is a diode.

4. The chip of claim 3, in which the second semiconductor device is a diode.

5. The chip of claim 4, in which the first MOS transistor is scaled larger than the second MOS transistor by a scale factor s, and the second diode is scaled larger than the first diode by a scale factor σ.

6. The chip of claim 5, in which a product of the s and σ scale factors is greater than 500.

7. The chip of claim 1, further comprising an amplifier circuit coupled to the temperature sensing circuit to amplify the signal to provide an amplified temperature signal.

8. The chip of claim 7, further comprising an analog to digital converter circuit coupled to the amplifier to convert the amplified temperature signal to a digital temperature signal.

9. The chip of claim 7, in which the amplifier is a differential amplifier utilizing an operational amplifier circuit.

10. A circuit, comprising:
(a) first and second transistors coupled together in a current mirror configuration;
(b) a first diode coupled to the first transistor; and
(c) a second diode coupled to the second transistor, wherein a temperature sensing signal is generated between the first and second diodes when the circuit is being operated.

11. The circuit of claim 10, in which the temperature sensing signal is a voltage signal that is substantially linearly proportional to the temperature of the diodes.

12. The chip of claim 10, in which the first and second transistors are MOS transistors.

13. The chip of claim 12, in which the first MOS transistor is scaled larger than the second MOS transistor by a scale factor s, and the second diode is scaled larger than the first diode by a scale factor σ.

14. The chip of claim 13, in which a product of the s and a scale factors is greater than 1.

15. The chip of claim 14, further comprising an amplifier circuit coupled to the temperature sensing circuit to amplify the signal to provide an amplified temperature signal.

16. The chip of claim 15, further comprising an analog to digital converter circuit coupled to the amplifier to convert the amplified temperature signal to a digital temperature signal.

17. The chip of claim 16, in which the amplifier is a dual complementary output differential amplifier circuit.

18. A system, comprising:
(a) a microprocessor having a
(i) first and second transistors coupled together in a current mirror configuration;
(ii) a first diode coupled to the first transistor; and
(iii) a second diode coupled to the second transistor, wherein a temperature sensing signal is generated between the first and second diodes when the circuit is being operated; and
(b) a component communicatively linked to the microprocessor.

19. The system of claim 18, in which the transistors and diodes are within a core of the microprocessor.

20. The system of claim 18, in which the microprocessor comprises circuitry to amplify and digitize the temperature signal to monitor temperature within the microprocessor.

21. The system of claim 18, in which the component is a wireless interface component.

22. The system of claim 18, in which the component is a hard disk drive component.
